(19) United States
(12) Patent Application Publication
(10) Pub. No.: US 2003/0026880 A1
(43) Pub. Date: Feb. 6, 2003

(54) Food composition

(76) Inventor: Nulean Jackson, Chicago, IL (US)

Correspondence Address: Matthew J. Peirce, Esq., 1550 Starlight Canyon Avenue, Las Vegas, NV, 89123, US

(21) Appl. No.: 09/921,967

(22) Filed: Aug. 6, 2001

(51) Int. Cl. A23L 1/00

(52) U.S. Cl. 426/557

(57) ABSTRACT

A new and improved edible food composition is disclosed that would be a macaroni salad. The food composition disclosed herein has a unique high density and texture compared to existing art. In addition, the ingredients disclosed herein give the food composition a unique taste not present in the prior art.

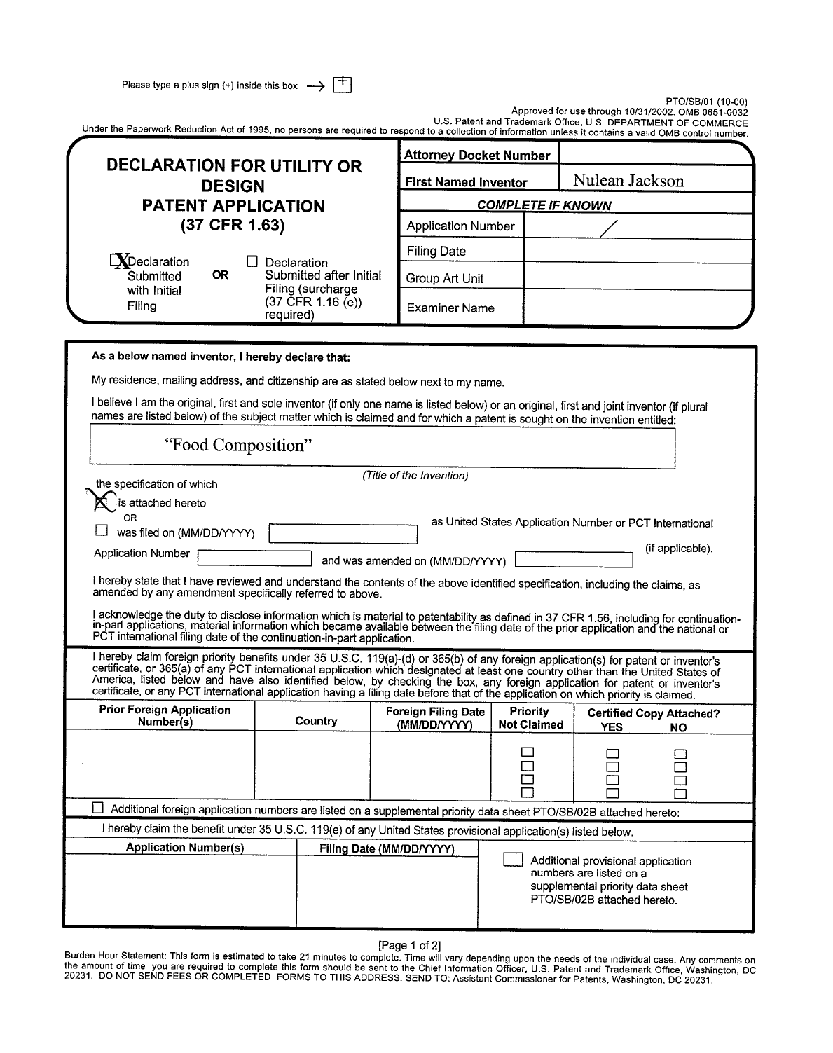

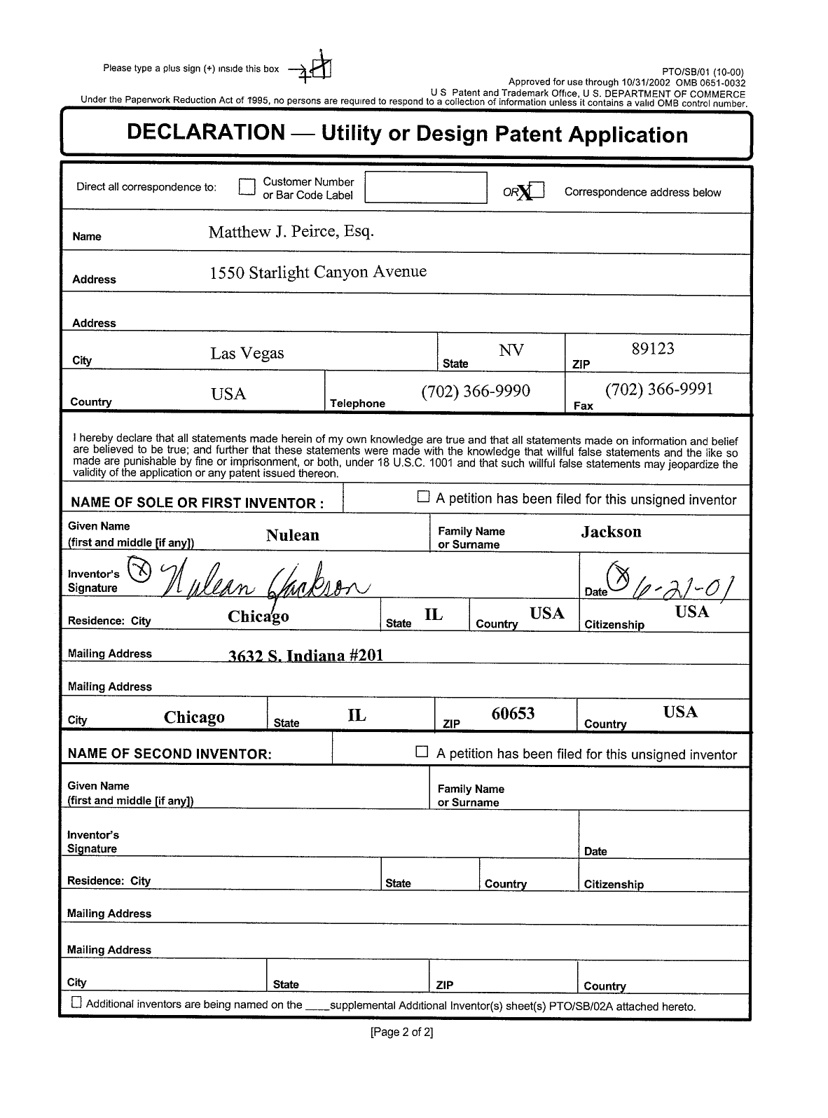

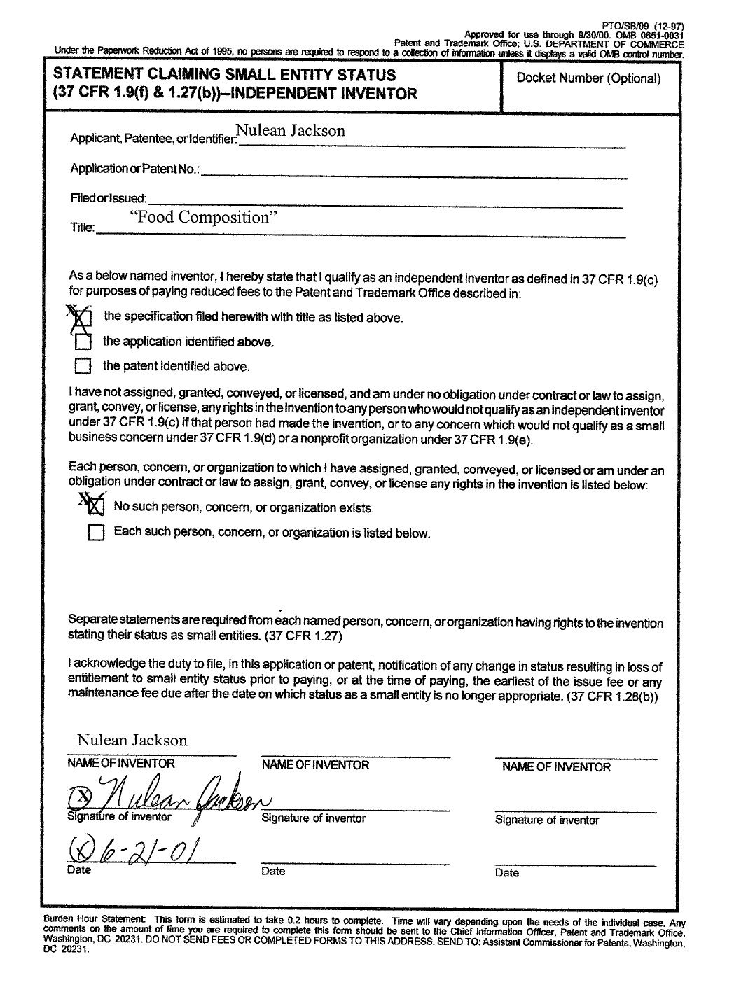

### I. BACKGROUND OF THE INVENTION

The present invention concerns that of a new and improved recipe for a food composition, and more particularly, a recipe for a macaroni salad.

### II. DESCRIPTION OF THE PRIOR ART

U.S. Pat. No. 4,599,238, issued to Saitoh, discloses a means for preparing noodles by boiling them with citric or lactic acid and table salt.

U.S. Pat. No. 4,394,397, issued to Lometillo, discloses a means for making instant pasta, such as macaroni, using a porous cellular structure.

U.S. Pat. No. 4,000,330, issued to Sipos, discloses a means for producing a pasta product such as macaroni.

### III. SUMMARY OF THE INVENTION

The present invention concerns that of a new and improved edible food composition that would be a macaroni salad. The food composition disclosed herein has a unique high density and texture compared to existing art. In addition, the ingredients disclosed herein give the food composition a unique taste not present in the prior art.

There has thus been outlined, rather broadly, the more important features of a food composition in order that the detailed description thereof that follows may be better understood and in order that the present contribution to the art may be better appreciated. There are, of course, additional features of the food composition that will be described hereinafter and which will form the subject matter of the claims appended hereto.

In this respect, before explaining at least one embodiment of the food composition in detail, it is to be understood that the food composition is not limited in its application to the details of construction and to the arrangements of the components set forth in the following description or illustrated in the drawings. The food composition is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present food composition. It is important, therefore, that the claims be regard as including such equivalent constructions insofar as they do not depart from the spirit and scope of the present invention.

It is therefore an object of the present invention to provide a food composition which has all of the advantages of the prior art and none of the disadvantages.

It is another object of the present invention to provide a food composition which may be easily and efficiently manufactured and marketed.

It is another object of the present invention to provide a food composition which is tasty and pleasing to a human palate.

It is yet another object of the present invention to provide a food composition which is economically affordable and available for the buying public.

Other objects, features and advantages of the present invention will become more readily apparent from the following detailed description of the preferred embodiment when considered with the appended claims.

### IV. DESCRIPTION OF THE PREFERRED EMBODIMENT

The macaroni salad of the present invention would have the following recipe:

½ pound of macaroni

5 egg whites

1 carrot stick

½ green bell pepper

1 teaspoon of celery seeds

2 Celery stalks

½ teaspoon salt

1 teaspoon pure granulated sugar

1 Tablespoon of salad dressing

1 Tablespoon salad sandwich spread

1 Teaspoon paprika

¼ Bottle creamy garlic dressing

½ package of Colby cheese, grated.

When making this recipe, a user would cook the macaroni and then drain the water from the macaroni. The macaroni used would preferably be Kraft brand macaroni. After this, a user would mix together all ingredients in a separate bowl, except for the paprika. A user would then sprinkle the paprika on top of the macaroni salad and serve.

What I claim as my invention is:

1. A food composition comprising the following ingredients:
½ pound of macaroni
5 egg whites
1 carrot stick
½ green bell pepper
1 teaspoon of celery seeds
2 Celery stalks
½ teaspoon salt
1 teaspoon pure granulated sugar
1 Tablespoon of salad dressing
1 Tablespoon salad sandwich spread
1 Teaspoon paprika
¼ Bottle creamy garlic dressing
½ package of Colby cheese, grated

2. A food composition according to claim 1 wherein the macaroni would preferably be Kraft brand macaroni.

3. A process of making a food composition comprising the steps of:
(a) cooking ½ pound of macaroni in a volume of water,
(b) draining the volume of water,
(c) mixing the following ingredients in with the macaroni:
5 egg whites
1 carrot stick
½ green bell pepper
1 teaspoon of celery seeds
2 Celery stalks
½ teaspoon salt
1 teaspoon pure granulated sugar
1 Tablespoon of salad dressing
1 Tablespoon salad sandwich spread
¼ Bottle creamy garlic dressing
½ package of Colby cheese, grated, and
(d) sprinkling one teaspoon of paprika on the resulting mixture.
